(19) United States
(12) Patent Application Publication
(10) Pub. No.: US 2008/0074977 A1
(43) Pub. Date: Mar. 27, 2008

(54) Optical Disc Apparatus

(75) Inventor: Takao Mizuno, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/902,609

(22) Filed: Sep. 24, 2007

(30) Foreign Application Priority Data
Sep. 27, 2006 (JP) 2006-261713

(51) Int. Cl. G11B 5/58; G11B 11/00; G11B 20/18; G11B 7/00; G11B 27/36

(52) U.S. Cl. 369/53.23

(57) ABSTRACT

An optical disc apparatus which can measures a focus error signal correctly while the optical disc is rotating even if an optical disc having the CAPA is loaded, includes a pickup head and a focus control portion that controls a focal point of a laser beam, and the apparatus measures the focus error signal on a surface of the optical disc while the optical disc is rotating before focus on, and adjusts a balance of the focus error signal based on the measured value.

This application is based on Japanese Patent Application No. 2006-261713 filed on Sep. 27, 2006, the contents of which are hereby incorporated by reference.

### BACKGROUND OF THE INVENTION

1. Field of the Invention

The present invention relates to an optical disc apparatus, in particular, an optical disc apparatus that reads data recorded on an optical disc such as a CD or a DVD and delivers a reproduced signal (an audio signal and a picture signal) based on the read data.

2. Description of Related Art

An optical disc apparatus performs various controls for reading data recorded on the optical disc correctly, which includes focus control for controlling a focal point of a laser beam that is projected onto the optical disc.

For example, JP-A-2000-222747 discloses an optical disc apparatus having a structure in which one of land and groove tracks is traced by the light beam continuously while a servo parameter is adjusted for each of the tracks in this state, and each adjustment result is stored and traced upon real recording or reproducing process, so that the servo parameter is read out, is adjusted and is set corresponding to a type of each track of the land or the groove.

In addition, JP-A-2002-269773 discloses an optical disc recording apparatus having a structure in which a laser beam is projected onto an optical disc having a track formed on it in a meandering manner at a predetermined period, a meandering period component included in a received light signal of returning light is detected, and a level balance between the received light signals that is used for calculating a servo error is automatically adjusted so that a level of the meandering period component becomes a minimum value.

In addition, JP-A-2002-288848 discloses an optical disc apparatus having a structure in which it is detected whether or not a position on an optical disc traced by an objective lens of an optical head is a data recording area, and a servo gain is corrected in accordance with the detection result so that an adjustment result is stored.

A general optical disc apparatus has a pickup head provided with a quadrant photo detector having four optical sensor elements arranged in rows and columns. Then, the focus control is performed by using a differential signal between a sum of reflection light quantity detected by the upper right and the lower left optical sensor elements and a sum of reflection light quantity detected by the upper left and the lower right optical sensor elements (hereinafter referred to as a focus error signal). The focus error signal is, as known well, a signal having S-shaped curve characteristic of the focal point with respect to the optical disc as shown in FIG. 7A. The horizontal axis is a displacement of the objective lens in FIG. 7A, and the right direction is the direction toward the optical disc.

As to reading of data from the optical disc, if reflection light quantity detected by the photo detector is larger, the read accuracy becomes higher. Therefore, the focus control in a general optical disc apparatus is performed as follows.

The focus control is control of moving the objective lens in the direction parallel to the optical axis of the laser beam. In general, the focal point is a point in which reflection light quantity from the optical disc detected by the photo detector (i.e., RF that is a sum of output signals of four optical sensor elements) becomes a maximum value, and it is called a reference point (Vref). In the focus control, the apparatus is adjusted so that a level of the focus error signal becomes zero at the reference point.

Therefore, it is ideal that the reference point is the point O that gives an average value of the focus error signal (the state shown in FIG. 7A). In real case, however, the reference point is shifted from the point O of the average value depending on accuracy of optical elements of the pickup head or the like (the state shown in FIG. 7B or 7C), having imbalance between the upper part and the lower part of the focus error signal. If the focus error signal shown in FIG. 7B or 7C is used for the focus control, there will be a problem that an out of focus state occurs easily (i.e., the objective lens moves easily to a position where the focus error signal cannot be obtained) so that the focus control becomes unstable, because the focus error signal is asymmetric with respect to the horizontal line Vref.

As a countermeasure of this problem, there is an optical disc apparatus that adjusts a balance of the focus error signal. This optical disc apparatus measures a focus error signal and adjusts a balance of the focus error signal based on the measurement result when an optical disc is loaded to the main body or when an instruction is issued to play an optical disc that is loaded to the main body.

However, the measurement of the focus error signal is performed on the data recording side of the optical disc, a correct value cannot be obtained unless the measurement is performed avoiding an influence of complementary allocated pit addressing (CAPA) when the focus error signal is measured for a DVD-RAM having the CAPA on the data recording side. Therefore, it is necessary to perform the measurement in the state where the optical disc is stopped. It is because that a part of the CAPA has higher ratio of optical reflection than other parts have, so reflection light intensity becomes large only in the part of the CAPA, which becomes a noise of the focus error signal.

In general, variation in the measurement of the focus error signal becomes smaller so that a correct value can be obtained if it is performed while the optical disc is rotating. In the case of the optical disc without the CAPA, there is no particular problem if the focus error signal is measured while the optical disc is rotating.

### SUMMARY OF THE INVENTION

In view of the above described problem, it is an object of the present invention to provide an optical disc apparatus that measures the focus error signal correctly while the optical disc is rotating, so that a balance of the focus error signal can be adjusted, even if an optical disc having the CAPA is loaded.

To attain the above described object, an optical disc apparatus in accordance with a first aspect of the present invention includes: a pickup head and a focus control portion that controls a focal point of a laser beam, and the apparatus is characterized by a structure in that the apparatus measures a focus error signal on a surface of an optical disc while the optical disc is rotating before focus on, and adjusts a balance of the focus error signal based on the measured value.

It is preferable that the balance is adjusted so that a substantially center value between a maximum value and a minimum value of the focus error signal becomes a reference level in the optical disc apparatus in accordance with a second aspect of the present invention.

It is preferable that the pickup head has a quadrant photo detector including four optical sensor elements arranged in rows and columns, and the photo detector detects reflection light of the laser beam that is projected onto the optical disc in the optical disc apparatus in accordance with a third aspect of the present invention.

It is preferable that the focus control portion moves an objective lens that is provided to the pickup head in a direction of an optical axis of the laser beam that is projected onto the optical disc, so as to control the focal point of the laser beam in the optical disc apparatus in accordance with a fourth aspect of the present invention.

An optical disc apparatus in accordance with a fifth aspect of the present invention includes: a motor that rotates an optical disc; a pickup head that has a quadrant photo detector including four optical sensor elements arranged in rows and columns, the photo detector detecting reflection light of the laser beam that is projected onto the optical disc, so as to read data recorded on the optical disc; a servo circuit including a focus control portion that controls a focal point of the laser beam by moving an objective lens that is provided to the pickup head in a direction of an optical axis of the laser beam that is projected onto the optical disc, and a motor control portion that controls rotation speed of the optical disc driven by the motor; a preamplifier that passes a focus error signal delivered by the pickup head to the servo circuit and receives data delivered by the pickup head so as to deliver the same; a buffer memory that stores the data delivered from the preamplifier; and a reproducing portion that reads out data stored in the buffer memory and delivers a reproduced signal based on the read data, and the apparatus is characterized by a structure in that the apparatus measures the focus error signal on a surface of the optical disc while the optical disc is rotating before focus on, and adjusts a balance of the focus error signal so that a substantially center value between a maximum value and a minimum value of the focus error signal becomes a reference level.

According to the present invention, the measurement of the focus error signal is performed by utilizing reflection light on the surface of the optical disc. Therefore, even if an optical disc having a CAPA is used, the focus error signal can be measured without affected by the CAPA while the optical disc is rotating. Therefore, the focus error signal can be measured with higher accuracy than a case where the focus error signal is measured in the stop state of the optical disc. Thus, a balance of the focus error signal can be adjusted more accurately.

### BRIEF DESCRIPTION OF THE DRAWINGS

FIG. 1 is a block diagram to show an example of a structure of an optical disc apparatus according to the present invention.

FIG. 2 is a diagram to show schematically a quadrant photo detector that is provided to a pickup head of the optical disc apparatus according to the present invention.

FIG. 3 is a diagram to show an example of a structure of a preamplifier of the optical disc apparatus according to the present invention.

FIG. 4 is a flowchart to show an example of an operation of the optical disc apparatus according to the present invention.

FIGS. 5A and 5B are diagrams for explaining a focus error signal that is measured when the optical disc apparatus of the present invention measures the focus error signal.

FIGS. 6A, 6B and 6C are diagrams for explaining the focus error signal whose bias is adjusted as to the optical disc apparatus of the present invention.

FIGS. 7A, 7B and 7C are diagrams for explaining a problem in the conventional optical disc apparatus.

### DETAILED DESCRIPTION OF THE PREFERRED EMBODIMENTS

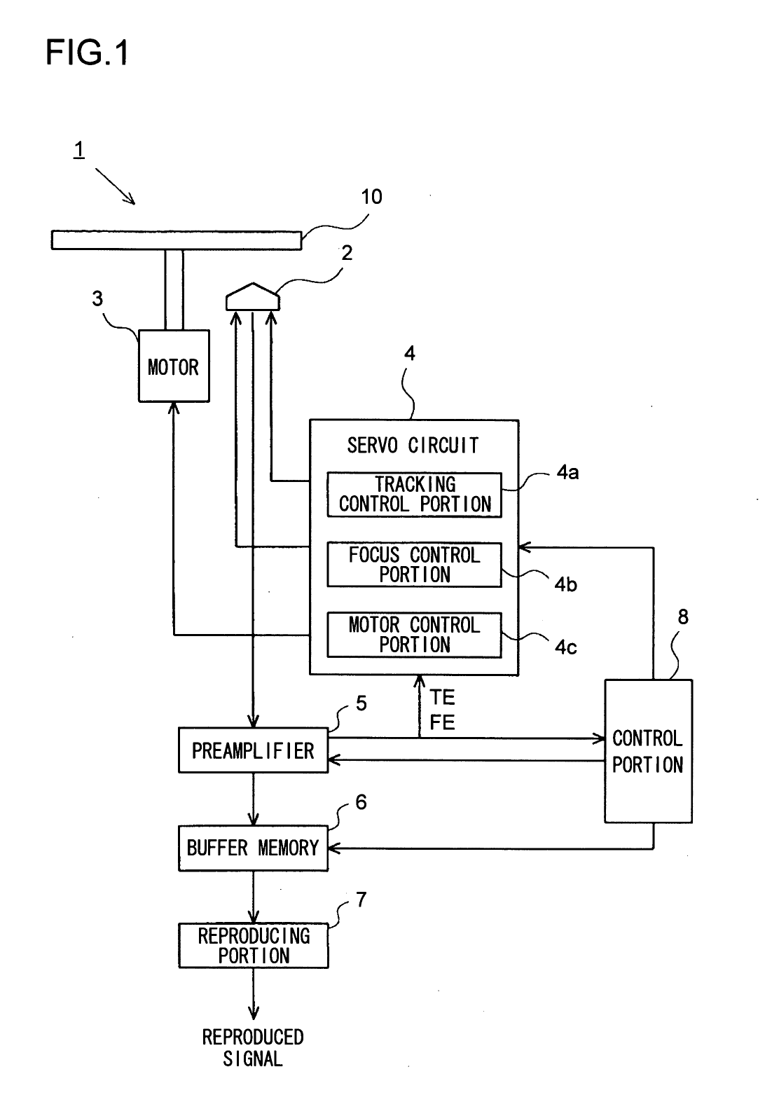

FIG. 1 is a block diagram to show an example of a structure of an optical disc apparatus. The optical disc apparatus 1 is equipped with a pickup head 2 for reading data that is recorded on an optical disc (such as a CD, a DVD, and the like) 10, a motor 3 for rotating the optical disc 10 that is loaded to a main body, and a servo circuit 4 for controlling a position of the pickup head 2 with respect to the optical disc 10 and a rotation speed of the optical disc 10 rotated by the motor 3.

The servo circuit 4 includes a tracking control portion 4a for controlling movement of the pickup head 2 in the radial direction (i.e., the horizontal direction) of the optical disc 10, a focus control portion 4b for controlling movement of the pickup head 2 in an optical axis direction of the laser beam (i.e., the direction of the rotation axis of the optical disc 10 or the direction perpendicular to the optical disc 10) and a motor control portion 4c for controlling a rotation speed of the motor 3.

An output of the pickup head 2 is supplied to a preamplifier 5. The preamplifier 5 receives a tracking error signal (TE) and a focus error signal (FE) from the pickup head 2 and delivers them to the servo circuit 4. The tracking error signal is a signal that indicates a deviation between the center of a track on the optical disc 10 and a spot position of the laser beam projected from the pickup head 2 as it is known well. The focus error signal is generally a signal indicating a deviation between the data recording surface of the optical disc 10 and the focal point of the laser beam emitted from the pickup head 2. However, when balance adjustment of the focus error signal is performed in the present invention as it will be described later, a signal indicating a deviation between the surface of the optical disc 10 and the focal point of the laser beam emitted from the pickup head 2 is used as the focus error signal.

In addition, the preamplifier 5 stores data that is read from the optical disc 10 in a buffer memory 6. The reproducing portion 7 reads out the data stored in the buffer memory 6 and delivers reproduced signals (i.e., an audio signal and a video signal) based on the read data. The control portion 8 controls operations of the main body.

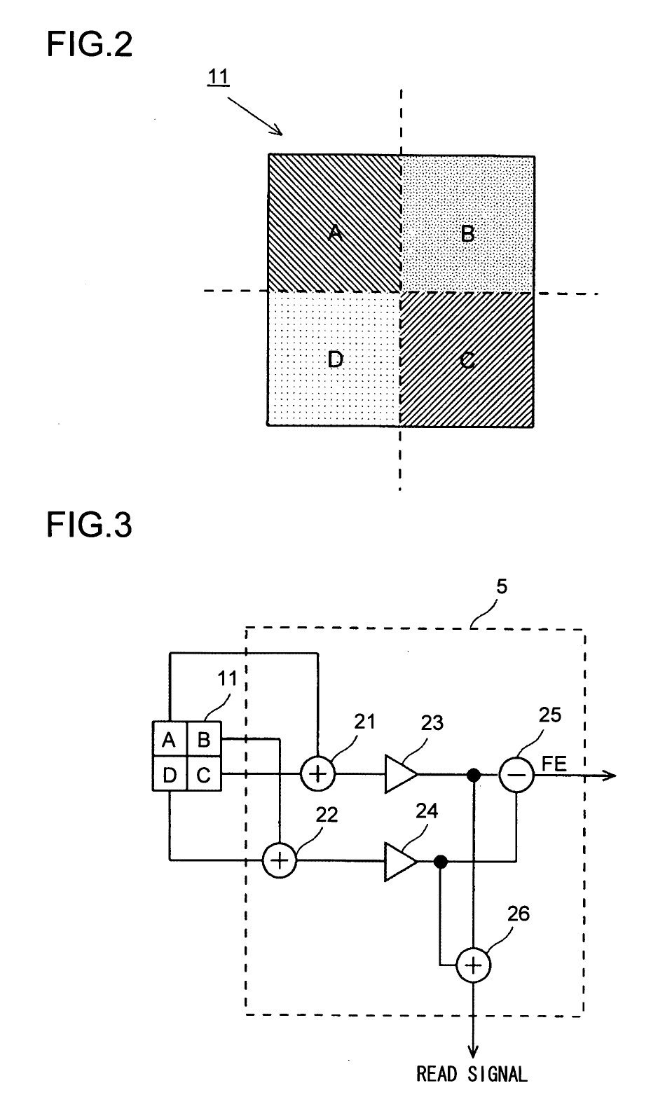

The pickup head 2 is provided with a quadrant photo detector 11 including four optical sensor elements A-D arranged in rows and columns (see FIG. 2). The preamplifier 5 receives outputs of the optical sensor elements A-D (see FIG. 3). The preamplifier 5 includes, as shown in FIG. 3, an adder 21 that adds outputs of the optical sensor element A and the optical sensor element C, an adder 22 that adds outputs of the optical sensor element B and the optical sensor element D, an amplifier 23 that amplifies an output of the adder 21, an amplifier 24 that amplifies an output of the adder 22, a subtracter 25 that produces a focus error signal (FE) that is a difference between the outputs of the amplifiers 23 and 24, and an adder 26 that produces a read signal that is a sum of the outputs of the amplifiers 23 and 24. Gains of the amplifiers 23 and 24 are adjusted individually by the control portion 8. In addition, there is provided a bias applying circuit that adds a bias to the focus error signal for adjusting an offset of the focus error signal though it is not shown in FIG. 3. The servo circuit 4 receives a focus error signal to which the bias is added by the bias applying circuit.

Although not shown in FIG. 3, the preamplifier 5 is also provided with a circuit for generating a tracking error signal by processing a signal from the pickup head 2 and supplying the tracking error signal to the servo circuit 4. This circuit may be a circuit that generates a differential signal between detectors (not shown) provided to the pickup head for a pair of side spots as the tracking error signal, or it may be a circuit that generates the tracking error signal by processing output signals of the four optical sensor elements A-D. Since these circuits are known well, description thereof will be omitted here.

Hereinafter, operations of the optical disc apparatus 1 will be described. The optical disc apparatus 1 measures the focus error signal at the timing when the optical disc 10 is loaded to the main body, when an instruction is issued to read the optical disc 10 that is loaded to the main body, or other timing, and performs a balance adjustment process for adjusting a balance of the focus error signal.

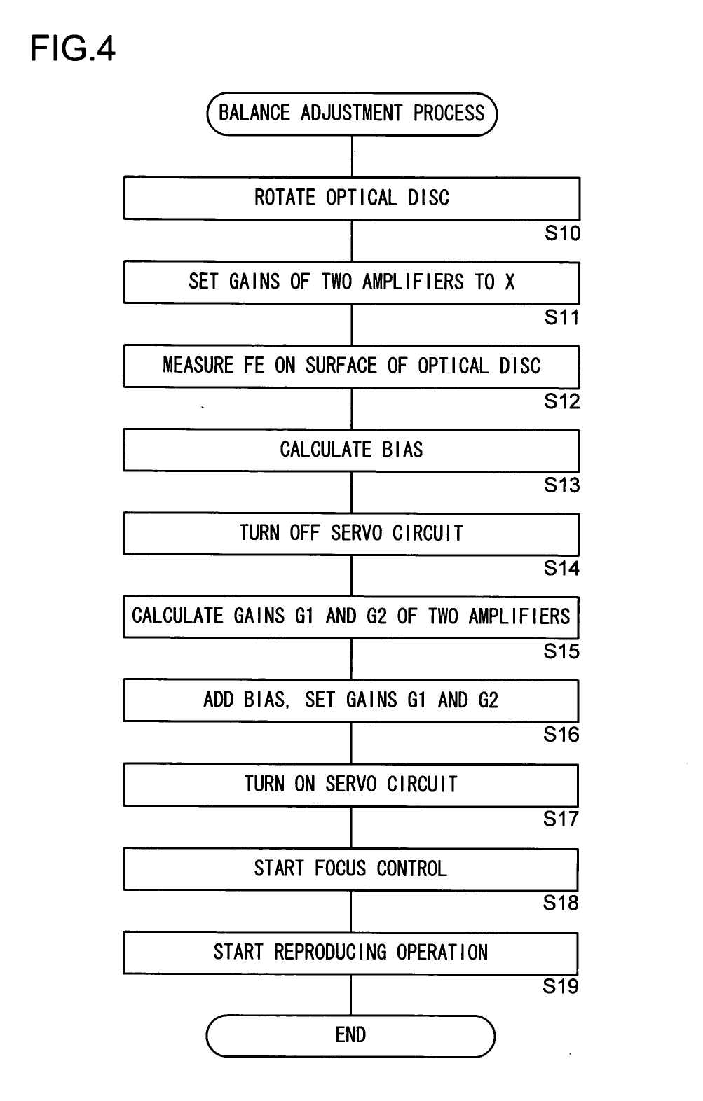

FIG. 4 is a flowchart to show the balance adjustment process. First, the optical disc apparatus 1 makes the optical disc in a rotating state in the step S10. Next, going to the step S11, the gains of the amplifiers 23 and 24 are set to a value X that is a predetermined value. After that, going to the step S12, the focus error signal on the surface of the optical disc is measured. In the measurement, a waveform of the focus error signal delivered from the subtracter 25 is measured while the objective lens of the pickup head 2 is moved gradually toward the optical disc 10.

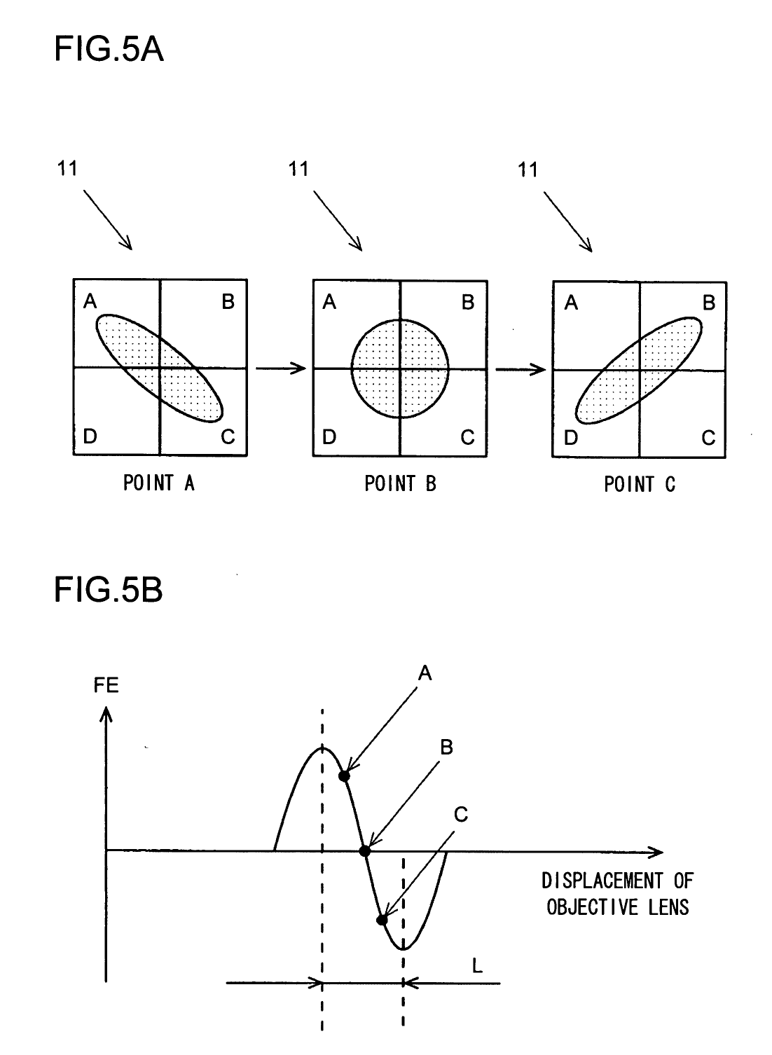

As known well, when the objective lens is moved gradually toward the optical disc 10, a shape of the beam spot of the reflection light from the optical disc 10 detected by the photo detector 11 changes in the order shown in FIG. 5A, so the focus error signal as shown in FIG. 5B is measured. In FIG. 5B, the horizontal axis indicates a displacement of the objective lens.

In addition, the optical disc apparatus 1 measures a position such that the objective lens when the reproduced signal (RF) delivered from the adder 26 becomes a maximum value, when the focus error signal is measured in the step S12. As described above, the optical disc apparatus 1 regards the point such that the reproduced signal measured here becomes a maximum value as a reference level of the focus error signal. In the step S13, the preamplifier 5 calculates the bias to be added to the focus error signal that is delivered from the subtracter 25, so that the reference level becomes a predetermined voltage, e.g., zero volts.

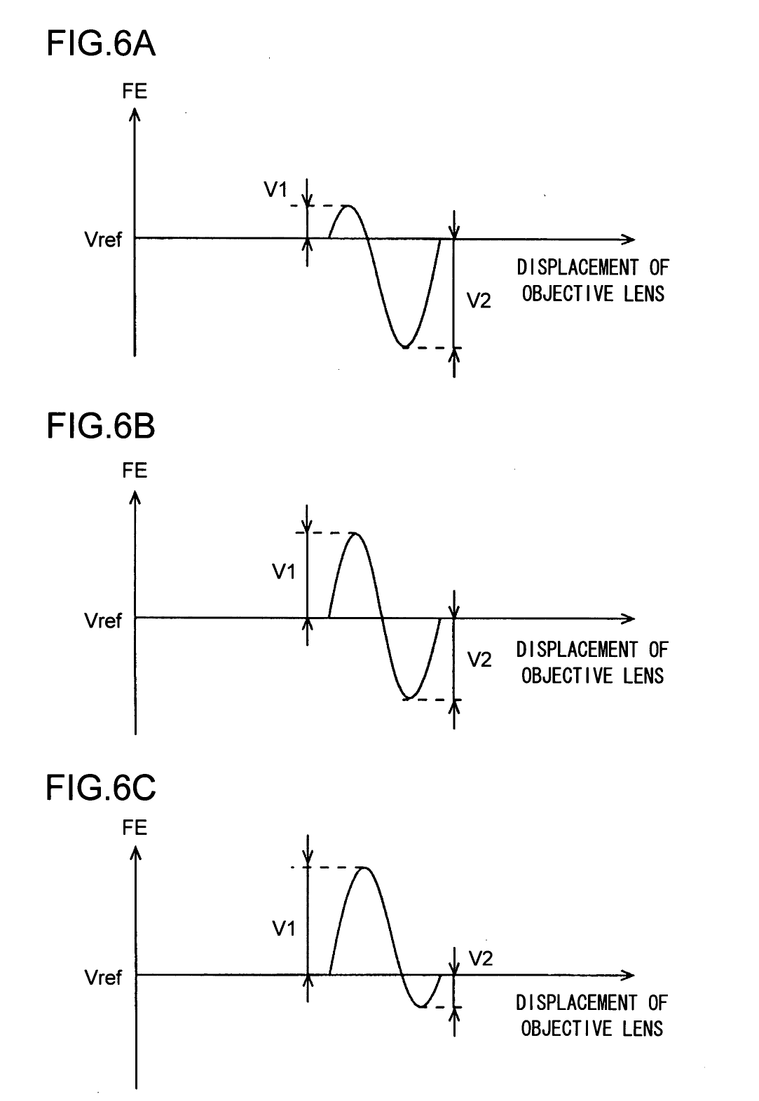

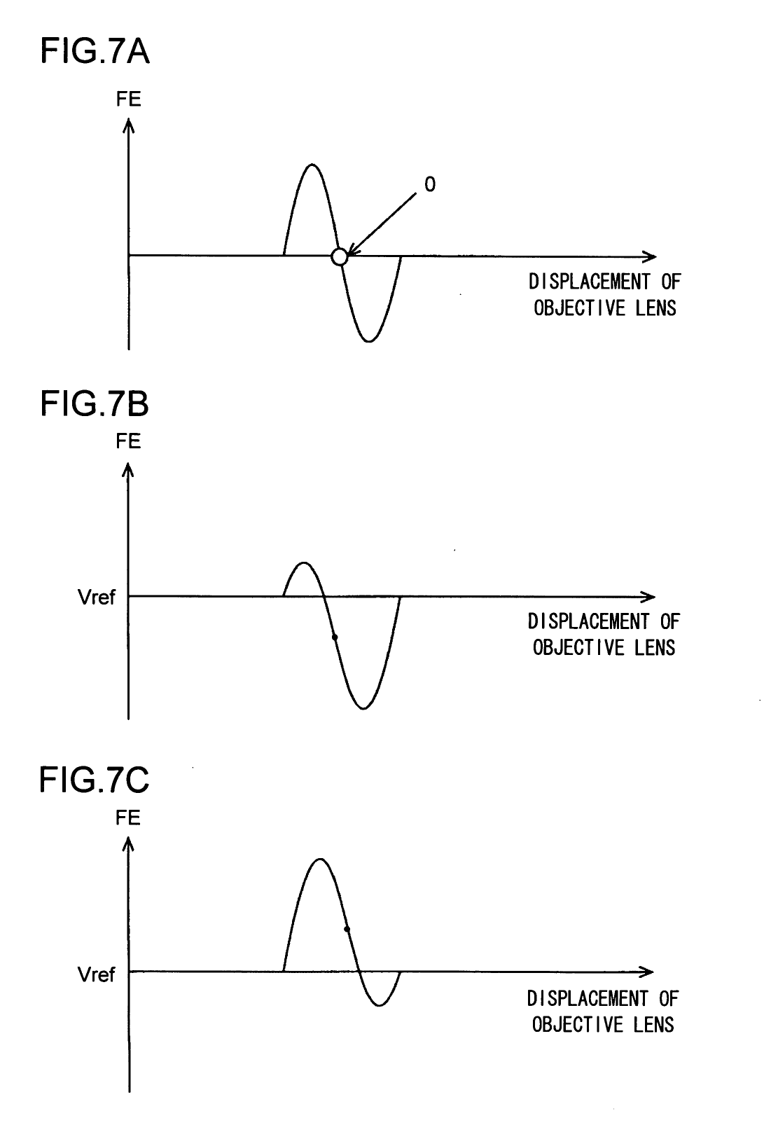

When the bias calculated in the step S13 is added to the focus error signal delivered from the subtracter 25, the focus error signal in the case where the reference level is the point A shown in FIG. 5B, for example, becomes a waveform shown in FIG. 6A. The focus error signal in the case where the reference level is the point B shown in FIG. 5B becomes a waveform shown in FIG. 6B. The focus error signal in the case where the reference level is the point C shown in FIG. 5B becomes a waveform shown in FIG. 6C.

Next, the optical disc apparatus 1 turns off the servo circuit 4 in the step S14. Thus, the movement of the objective lens of the pickup head 2 is restricted. Note that the process in the step S14 may be performed before the step S13.

Next in the step S15, the optical disc apparatus 1 calculates a gain G1 of the amplifier 23 and a gain G2 of the amplifier 24. The calculation of the gains G1 and G2 in the step S15 is performed as will be described below.

The optical disc apparatus 1 calculates the gain G1 of the amplifier 23 so that a potential difference between the maximum value of the focus error signal measured in the step S13 and the reference level becomes a predetermined potential difference V. The apparatus also calculates the gain G2 of the amplifier 24 so that a potential difference between the minimum value of the focus error signal measured in the step S13 and the reference level becomes a predetermined potential difference V.

After calculating the gains G1 and G2 of the amplifiers 23 and 24 in the step S15, going to the step S16, the optical disc apparatus 1 adds the bias calculated in the step S13 to the focus error signal that is delivered from the subtracter 25, so as to set the gains G1 and G2 of the amplifiers 23 and 24 to the values calculated in the step S15. After that, going to the step S17, the optical disc apparatus 1 turns on the servo circuit 4 that was turned off in the step S14. Then, going to the step S18, it starts the focus control and starts reproducing operation after the track on in the step S19.

Note that the optical disc apparatus 1 also starts tracking control when the focus control is started in the step S18.

When the process in the step S16 is finished, a balance of the focus error signal delivered from the subtracter 25 is adjusted in the optical disc apparatus 1 so that the maximum value and the minimum value are substantially symmetric with respect to the above-mentioned reference level as the waveform shown in FIG. 6B. Therefore, in the reproducing operation performed in the step S19, the focus error signal having the adjusted balance is used for the focus control, so that stable focus control can be performed and out of focus state during the reproducing operation can be suppressed.

In this way, the optical disc apparatus 1 according to the present invention has a function of adjusting a balance of the focus error signal, and a focus error signal having a balance adjusted by the function is used for focus control. Thus, stable focus control can be performed.

In addition, the measurement of the focus error signal is performed by using the reflection light on the surface of the optical disc. Therefore, even if a DVD-RAM having the CAPA is used, a focus error signal that is hardly affected by the CAPA can be measured while the DVD-RAM is rotating. Thus, a focus error signal can be measured with higher accuracy than the case where the focus error signal of the static optical disc is measured, so that a balance of the focus error signal can be adjust more accurately.

The optical disc apparatus according to the present invention can be applied to ones that read data recorded on an optical disc such as a CD, a DVD or the like, and reproduce the read data. In particular, it can be applied to ones that support various standards of optical discs.

What is claimed is:

1. An optical disc apparatus comprising a pickup head and a focus control portion that controls a focal point of a laser beam, wherein
the apparatus measures a focus error signal on a surface of an optical disc while the optical disc is rotating before focus on, and adjusts a balance of the focus error signal based on the measured value.

2. The optical disc apparatus according to claim 1, wherein the balance is adjusted so that a substantially center value between a maximum value and a minimum value of the focus error signal becomes a reference level.

3. The optical disc apparatus according to claim 2, wherein the pickup head has a quadrant photo detector including four optical sensor elements arranged in rows and columns, and the photo detector detects reflection light of the laser beam that is projected onto the optical disc.

4. The optical disc apparatus according to claim 3, wherein the pickup head has a quadrant photo detector including four optical sensor elements arranged in rows and columns, and the photo detector detects reflection light of the laser beam that is projected onto the optical disc.

5. The optical disc apparatus according to claim 1, wherein the focus control portion moves an objective lens that is provided to the pickup head in a direction of an optical axis of the laser beam that is projected onto the optical disc, so as to control the focal point of the laser beam.

6. The optical disc apparatus according to claim 2, wherein the focus control portion moves an objective lens that is provided to the pickup head in a direction of an optical axis of the laser beam that is projected onto the optical disc, so as to control the focal point of the laser beam.

7. The optical disc apparatus according to claim 3, wherein the focus control portion moves an objective lens that is provided to the pickup head in a direction of an optical axis of the laser beam that is projected onto the optical disc, so as to control the focal point of the laser beam.

8. The optical disc apparatus according to claim 4, wherein the focus control portion moves an objective lens that is provided to the pickup head in a direction of an optical axis of the laser beam that is projected onto the optical disc, so as to control the focal point of the laser beam.

9. An optical disc apparatus comprising:
a motor that rotates an optical disc;
a pickup head that has a quadrant photo detector including four optical sensor elements arranged in rows and columns, the photo detector detecting reflection light of the laser beam that is projected onto the optical disc, so as to read data recorded on the optical disc;
a servo circuit including a focus control portion that controls a focal point of the laser beam by moving an objective lens that is provided to the pickup head in a direction of an optical axis of the laser beam that is projected onto the optical disc, and a motor control portion that controls rotation speed of the optical disc driven by the motor;
a preamplifier that passes a focus error signal delivered by the pickup head to the servo circuit and receives data delivered by the pickup head so as to deliver the same;
a buffer memory that stores the data delivered from the preamplifier; and
a reproducing portion that reads out data stored in the buffer memory and delivers a reproduced signal based on the read data, wherein
the apparatus measures the focus error signal on a surface of the optical disc while the optical disc is rotating before focus on, and adjusts a balance of the focus error signal so that a substantially center value between a maximum value and a minimum value of the focus error signal becomes a reference level.
